(19) United States
(12) Patent Application Publication
(10) Pub. No.: US 2013/0280072 A1
(43) Pub. Date: Oct. 24, 2013

(54) Air-Jet Wind Turbine Generator

(71) Applicant: Kechao Ma, Zhenjiang (CN)

(72) Inventor: Kechao Ma, Zhenjiang (CN)

(21) Appl. No.: 13/814,431

(22) PCT Filed: Sep. 27, 2011
(86) PCT No.: PCT/CN2011/080238

§ 371 Date: Jun. 14, 2013

(30) Foreign Application Priority Data
Oct. 28, 2010 (CN) 201010522549.9

(51) Int. Cl. F03D 9/00

(52) U.S. Cl. CPC F03D 9/002
USPC 416/144

(57) ABSTRACT

An air jet wind turbine generator comprises an air jet installed at the end of each turbine blade. The air jets are perpendicular to the turbine blades and capable of outputting a recoil velocity that is also equal to or within ±20 degrees of the linear velocity of the turbine blade ends. The air jets utilize a counteracting force to accelerate or decelerate each turbine blade and to compensate the rotating speed of the wind turbine. The air volume and speed of the air jets can be adjusted via a speed sensor, thereby constantly maintaining the wind turbine generator rotating speed at the set speed.

### FIELD OF THE INVENTION

This invention relates to a wind power generator, especially a wind power generator with constant rotation speed output.

### BACKGROUND OF THE INVENTION

When wind blows, wind turbine generator rotates in response to the wind, and the speed of rotation is determined by how strong the wind is. The main indispensable elements for feeding the power generated into the power grid include phase sequence, voltage and frequency. The reason that power generated by wind turbine generator cannot be directly fed to the power grid is that the speed of rotation of wind turbine is unstable, leading to unstable frequency. Therefore, it is not feasible to use the three-phase alternating current generators or synchronous generators. Instead, permanent magnet generators or doubly-fed induction generators are common units used for wind turbines. The output electric energy of such generator units is not 50 Hz alternating current electricity and cannot be directly connected to the power grid. Consequently, the kinetic energy of wind needs to be converted into direct current electricity or even chemical energy before converting into the electric energy that can be connected to the power grid through inverter or current converter. The electric energy converted from the inverter or current converter is usually in the form of square wave or trapezoidal waves, the quality of which is poorer than the sine wave in the power grid. Such electric energy may result in significant negative effects to the electric appliances. Moreover, the converting process itself needs large energy consumption, which decreases energy efficiency and increases the cost of the power generation.

As the generated output increases, the diameter and size of wind turbines increase, leading to increasing difficulty of manufacturing and installation, and capital cost. Most of the current wind turbines use rotary wing structure. Currently, technologies for wind turbine generators with the capacity of 2-3 MW have already developed into the mature stage. In order to produce stable electric energy output, most generators use large battery packs to convert the power generated into chemical energy. The life expectancy of these battery packs is limited and the disposal of these battery packs has harmful environmental impacts. These factors affect the efficiency and sustainability of current wind turbine engines.

### SUMMARY OF THE INVENTION

An air jet wind turbine generator according to this invention improves the current horizontal axis wind turbine generator, and further provides an air jet wind turbine generator with constant rotation speed output.

According to the present invention, an air jet is installed at the end of each turbine blade of the wind turbine. The air jets are provided perpendicular to the turbine blades and are capable of outputting a recoil velocity that is also equal to or within ±20 degrees of the linear velocity of the turbine blade ends. The air jets utilize a counteracting force of the air stream to accelerate or decelerate each turbine blade, and the counteracting force can compensate the rotation speed of the wind turbine either positively or negatively, resulting in constant rotation speed of the wind turbine. The above-mentioned air jets are axial fans, which are mechanical devices installed on the ends of each turbine blade. In practical applications, the energy generated by the blades, wheels and main axle is transmitted to the speed increasing gearbox to generate electric energy. The generator unit of air jet wind turbine generator is three phase synchronous generator or asynchronous generator, which is same as those used in thermal power generators or hydropower generators. Hence, electricity generated by air jet wind turbine generators can be fed into the power grid directly.

This invention provides a method for maintaining constant speed of rotation of the wind turbine blades. Combined with an appropriate number of generator poles, the generator can produce electricity with the same frequency as the frequency of the power grid, particularly in the form of sine waves. The rotor of the generator under appropriate and constant rotation speed produces electricity that meets the requirements of the power grid.

With the lever effect of the counteracting force from the air adjusted by the jet, the rotation speed of the wind power generator can be stabilized over a relative large range. Generally, the jet flow rate is in the range between 5 m/s and 80 m/s. In force 3-8 wind, the jet rotates counterclockwise, but the jet rotates clockwise in force 9-12 wind. The air current changes from the jet accelerate or decelerate the rotation speed of the wind turbine generator. The normal working condition of the jet is in force 3-8 wind. However, in order to fully utilize wind resources in different regions, it is possible to adjust the flow rate of the jet according to the wind condition in the region that the wind turbine is being used.

According to the present invention, the speed of rotation of the wind turbine is automatically adjusted by the air jet by first measuring rotation speed of the main axle of the wind turbine or the generator unit, using a Hall sensor or a photoelectric sensor. The measured rotation speed is then compared to a set speed of the wind turbine. In response to this comparison, and also based on the speed of the wind and the power load, the flow rate of the jet is instantaneously and accurately adjusted.

According to this invention, the wind turbine generator only consumes relative low energy to maximize and normalize the power and efficiency of the wind generator in force 2-11 winds. The energy consumption of the air jet is about 0.5-5%, and is negligible within a certain range of wind speeds. The wind turbine generators stop working when the speed of wind is less than 3 m/s, otherwise it breaks the law of energy conservation. In general, the wind turbine generator will run as long as the power generated is larger than the energy consumed. This invention has significant meaning to the development of the wind power generation industry.

The beneficial results of this invention are described as follows: air jets are installed at the ends of each blades of the wind turbine as an external driving force for the generator, which will improve the efficiency of the wind turbine generator. Based on the set rotation speed of the wind turbine generator, the air jet will adjust the air volume and rotation speed of the jet automatically based on the signal from a speed sensor. With the adjustment, the air jet ensures that the rotation speed of the wind turbine generator is constant. The air jet can automatically adjust the rotation speed of the wind turbine generator in force 2-11 winds according to the energy consumption loading. Therefore, it ensures the stability of the rotation speed of the wind turbine generator. Under such conditions, the electricity generated can be directly fed to the power grid. Under the same operation conditions as traditional wind turbines, the air jet wind turbine generator has smaller volume and shorter blades. The addition of the air jets improves the efficiency of the generator and promotes the development towards larger capacity generator unit.

### BRIEF DESCRIPTION OF THE DRAWINGS

FIG. 1 is the assembly diagram of the air jet wind turbine generator

FIG. 2 is the perspective view of the air jet

FIG. 3 is the cross -section drawing of the air jet

FIG. 4 is the assembly diagram for the blades of the wind turbine generator

FIG. 5 is the circuit diagram for the horizontal commutator, vertical commutator and engine.

### DETAILED DESCRIPTION OF THE INVENTION

The air jet wind turbine generator according to this inventions consists of wind turbine generator 1, wind turbine blades 2, air jet 3, tower 4, tower foundation 5, blades of air jet 6, mount bracket of the motor 7, motor 8, casing of the air jet (duct) 9, horizontal commutator 10 and vertical commutator 11. Air jets are installed on the ends of the turbine blades of the wind turbine generator to adjust the rotation speed of the jet and the direction of the air flow according to the set speed of rotation speed the wind turbine generator.

This invention has adapted aerodynamics and lever principle to maintain the constant rotation speed of the wind turbine generator. When natural wind is insufficient or too strong, the air jet can provide effective compensation to the rotation speed of the wind turbine in the positive or negative direction. The air jet utilizes fuzzy logic control to automatically compensate the rotation speed of the wind turbine based on the set speed of rotation. Now that the rotation speed of the wind turbine is effectively controlled, electricity generation by the air jet wind turbine generator is under control. Therefore, the quality of the output electricity meets the requirements to be directly fed into the power grid.

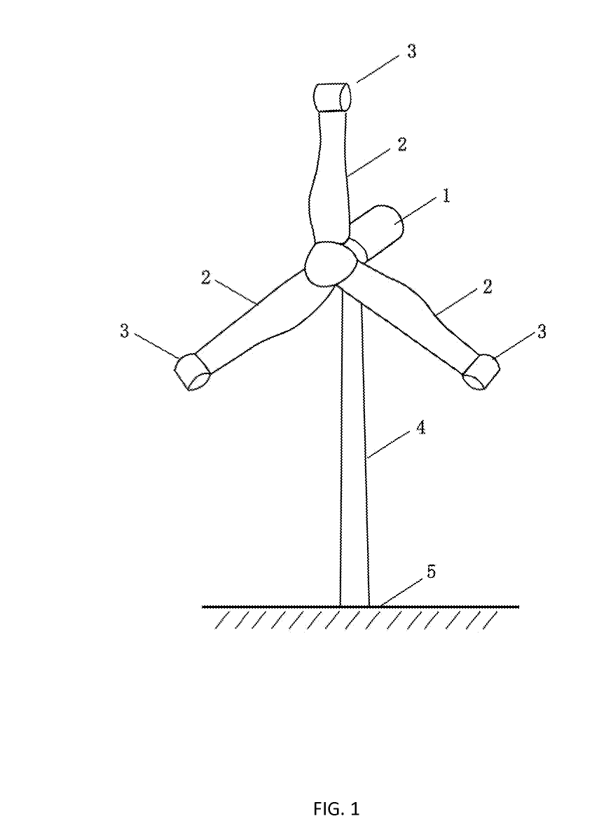

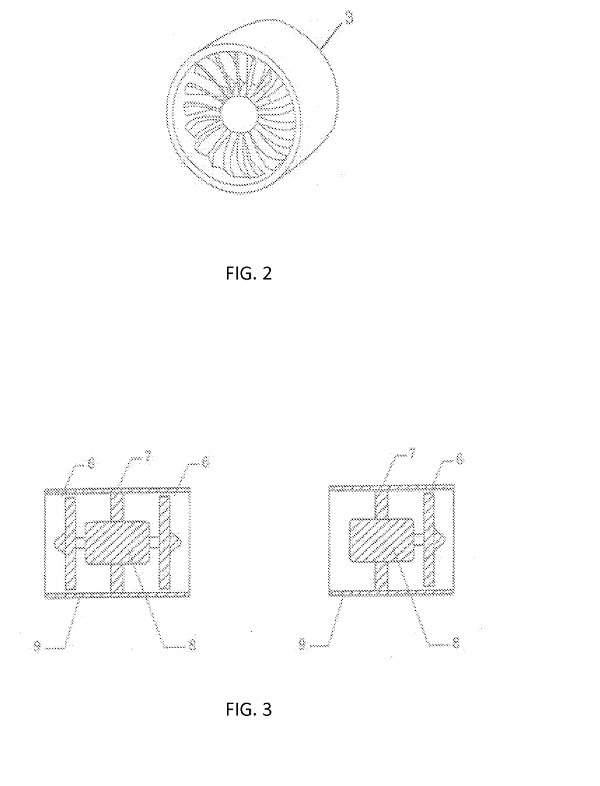

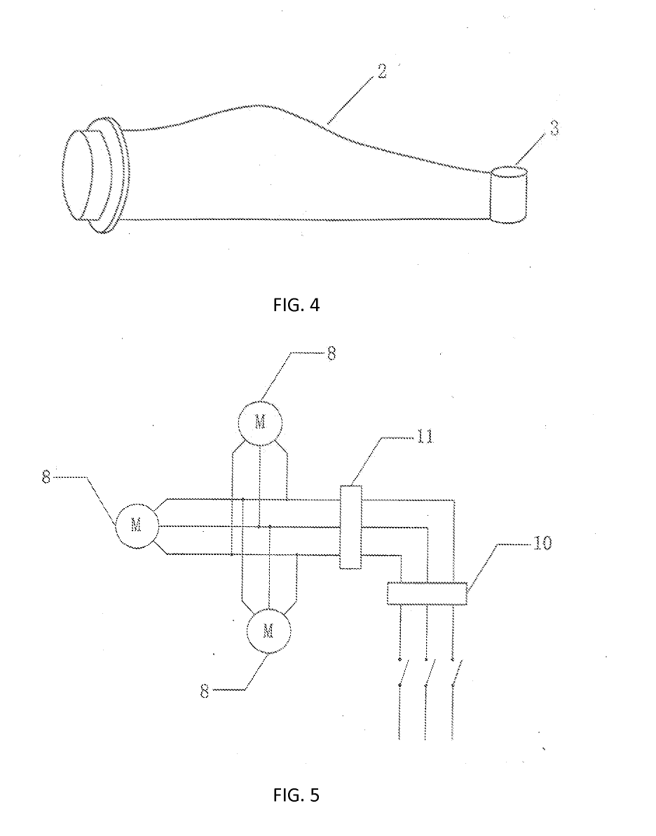

The air jet 3 is located at the end of the blade of the wind turbine generator (see FIG. 1) to maximize the lever effect. The casing of jet engine and the blades of the generator are integrated or assembled structures made of carbon fiber reinforced skeleton and glass reinforced plastic (see FIG. 4), which are manufactured with polymer material. The air jet is powered by variable speed frequency-inverter motor 8 (direct current or alternating current) or direct current motor. As for the power supply structure, power can be supplied to the motor of the air jet 8 through a horizontal commutator 10, a vertical commutator 11 and conducting wires. The horizontal commutator 10 is installed on the rotator of the wind turbine and the vertical commutator 11 is located on the main axle of the blades respectively. Both commutators have adapted the ring type brush power transmission structure (see FIG. 5). There are two types of air jets 3 available: single blade machine or double-blade machine (the right panel of FIG. 3 is the single blade type and the left panel is the double-blade type). The blades of the air jet are turbine blades or each consisting of two or more blades with impellers (see FIG. 2). The material of blades is metal or polymer material. The rated power of the air jet (motor 8) is from 0.1-100 kw, depending on the power of the wind turbine generator.

In the intelligent control system of the air jet, the program for the rotation speed of the air jet 3 is mainly based on the set rotation speed of the wind turbine generator and the strength of the wind. The air jet automatically provides negative and positive compensation to the rotation speed of the wind turbine (by accelerating or decelerating the rotation speed of the jet) based on signals from the rotation speed sensor. With the speed compensation from the air jet, it is possible to maintain the rotation speed of the wind turbine to be within the set range, which ensures that electricity generated can be fed into to the power grid directly. This invention provides means to overcome limitations on power generation by natural wind resources, making wind power a reliable source of green energy.

The air jets 3 are installed on the ends of the blades of the wind turbine generator in order to maximize the lever effect However, air jets may be installed at any position on the blades and achieve the same functions, which falls within the scope of this invention. Also, a duct is installed in the assembly of the air jet, which improves the counteracting force of the air current through the jet. An air jet assembly without duct falls within the scope of this invention.

What is claimed is:

1. An air jet wind turbine generator, comprising an air jet that is installed at the end of each rotating blade of the wind turbine, wherein the air jets are provided perpendicular to the turbine blades and are capable of outputting a recoil velocity that is also equal to or within ±20 degrees of the linear velocity of the turbine blade ends, the air jets utilizing a counteracting force of the air to accelerate or decelerate each turbine blade, and the counteracting force compensating the rotating speed of the wind turbine either positively or negatively, maintaining constant rotation speed of the wind turbine.

2. The air jet wind turbine generator of claim 1, wherein the air jet is an axial fan or any device that generates air flow or airburst.

3. The air jet wind turbine generator of claim 1, wherein the generator adapts three-phase alternating current generators or synchronous generator, converting the kinetic energy of wind transmitted through the speed increasing gearbox to electricity with the same frequency as the power grid.

4. The air jet wind turbine generator of claim 1, wherein the rotation speed of the wind turbine is adjusted according to the measured rotation speed of the main axle of the wind turbine or the generator unit using a Hall sensor or a photoelectric sensor, and is automatically compensated to maintain a constant rotation speed based on the speed of the wind, the power load and the set rotation speed of the wind turbine.

5. The air jet wind turbine generator according to claim 1, wherein power is supplied to the motor of the air jet through a horizontal commutator, a vertical commutator and conducting wires, wherein the horizontal commutator is installed on the rotator of the wind turbine and the vertical commutator is located on the main axle of the blades, and commutators having adapted the ring type brush power transmission structure.

6. (canceled)

7. The air jet wind turbine generator according to claim 1, wherein the air jet is located at the end of the blade of the wind turbine generator, and the casing of the air jet and the blades of the generator being integrated or assembled structures made of carbon fiber reinforced skeleton and glass reinforced plastic, which are manufactured with polymer material.

8. The air jet wind turbine generator according to claim 1, wherein the air jet has an intelligent control system to control the rotation speed of the wind turbine to be within a set range, automatically providing positive or negative compensation by accelerating or decelerating air through the air jet, based on the set rotation speed of the wind turbine generator, the speed of the wind and the power load of the generator.

9. The air jet wind turbine generator according to claim 1, wherein the air jets can be installed at any position on the blades of the wind turbine.

10. The air jet wind turbine generator according to claim 1, wherein two types of air jets maybe used, a single blade type or a double-blade type, the blades of the air jets being turbine blades or each consisting of two or more blades and with impellers, and the power of the air jet being 0.1-100 kw.
